(19) United States
(12) Patent Application Publication
(10) Pub. No.: US 2026/0206011 A1
(43) Pub. Date: Jul. 16, 2026

(54) MANAGEMENT APPARATUS AND COMMUNICATION CONTROL METHOD

(71) Applicant: JVCKENWOOD Corporation, Yokohama-shi (JP)

(72) Inventor: Masamichi Nishioka, Yokohama-shi (JP)

(21) Appl. No.: 19/561,618

(22) Filed: Mar. 10, 2026

Related U.S. Application Data
(63) Continuation of application No. PCT/JP2024/033323, filed on Sep. 18, 2024.

(30) Foreign Application Priority Data
Sep. 26, 2023 (JP) 2023-163016
May 14, 2024 (JP) 2024-078642

(51) Int. Cl. H04W 72/0446; H04W 28/22; H04W 72/121; H04W 72/52; H04W 76/10; H04W 76/36

(52) U.S. Cl. CPC H04W 72/0446; H04W 28/22; H04W 72/121; H04W 72/52; H04W 76/10; H04W 76/36

(57) ABSTRACT

On receiving a new connection request via a control slot in a state where all call slots are used for calls, a management apparatus deals with the connection request. The management apparatus includes a slot division determination unit that, in a case where there is no empty call slot and in-use terminal devices using an inquiry subject slot among in-use call slots are able to change a bit rate, determines that the inquiry subject slot is a dividable slot; and a slot allocation unit that allocates the in-use terminal devices and a request terminal device having made the new connection request respectively to slots obtained by division. In a case where the inquiry subject slot is used for a group call, the slot division determination unit determines that the inquiry subject slot is the dividable slot when the number of in-use terminal devices having responded that the bit rate is changeable meets a given condition.

### CROSS-REFERENCE TO RELATED APPLICATIONS

This application is a Continuation of PCT International Application No. PCT/JP2024/033323 filed on Sep. 18, 2024 which claims the benefit of priority from Japanese Patent Application No. 2023-163016, filed on Sep. 26, 2023 and Japanese Patent Application No. 2024-078642, filed on May 14, 2024, the entire contents of all of which are incorporated herein by reference.

### BACKGROUND OF THE INVENTION

### 1. Field of the Invention

The present disclosure relates to a management apparatus and a communication control method.

### 2. Description of the Related Art

A trunking radio communication system that includes a plurality of radio terminal devices and a plurality of repeaters has been known. For example, Japanese Laid-open Patent Publication No. 2015-2449 discloses a technique that makes it possible to shorten a time required for a process of registering positions of radio terminal devices in a trunking system.

In a trunking system, when there is a terminal device that makes a new connection request and there is no empty slot to be used as a channel, a busy signal indicating that it is not possible to establish a connection is transmitted to the terminal device that makes a new connection request, thereby rejecting connection. If it is possible to generate an empty slot from a state without any empty slot and then allocate the empty slot to a terminal device that makes a new connection request, it is possible to reduce connection rejection. In order to generate a new empty slot, however, it is necessary to divide a slot in use and generate an empty slot and then allocate the new slot to a terminal device that is using a slot or a terminal device that makes a new connection request. When the terminal device that is using a slot cannot cope with a bit rate required in communication using the allocated new slot, the terminal device is unable to continue a call. When the terminal device that makes a new connection request cannot cope with a bit rate that is required for communication using the slot that is newly allocated, the terminal device is unable to establish communication. It is necessary to confirm that communication can be established with a slot that is newly allocated and allocate the slot appropriately to a terminal device that is using a slot and a terminal device that has made a connection request anew.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

A management apparatus according to the present disclosure that has a plurality of slots and that, on receiving a new connection request via a control slot in a state where all call slots are used for calls, deals with the connection request, the management apparatus comprising: a communication unit that communicates with a terminal device, using the call slot and the control slot; a slot division determination unit that, on receiving a new connection request via the control slot when there is no empty call slot, selects an inquiry subject slot from the in-use call slots based on a given condition, that makes an inquiry on whether or not a bit rate is changeable to in-use terminal devices using the selected inquiry subject slot, and that, when the in-use terminal devices respond that the bit rate is changeable, determines that the inquiry subject slot is a dividable slot; a slot division control unit that makes an instruction to change the bit rate to the in-use terminal devices and that divides the dividable slot; and a slot allocation unit that allocates the in-use terminal devices and a request terminal device having made the new connection request respectively to slots obtained by the division, wherein, in a case where the inquiry subject slot is used for a group call, the slot division determination unit determines that the inquiry subject slot is the dividable slot when the number of in-use terminal devices having responded that the bit rate is changeable in the in-use terminal devices meets a given condition.

A communication control method of, with a plurality of slots, on receiving a new connection request via a control slot in a state where all call slots are used for calls, dealing with the connection request, the method according to the present disclosure comprising: communicating with a terminal device, using the call slot and the control slot; on receiving a new connection request via the control slot when there is no empty call slot, selecting an inquiry subject slot from the in-use call slots based on a given condition, making an inquiry on whether or not a bit rate is changeable to in-use terminal devices using the selected inquiry subject slot, and, when the in-use terminal devices respond that the bit rate is changeable, determining that the inquiry subject slot is a dividable slot; making an instruction to change the bit rate to the in-use terminal devices and dividing the dividable slot; allocating the in-use terminal devices and a request terminal device having made the new connection request respectively to slots obtained by the division, in a case where the inquiry subject slot is used for a group call, determining that the inquiry subject slot is the dividable slot when the number of in-use terminal devices having responded that the bit rate is changeable in the in-use terminal devices meets a given condition.

### BRIEF DESCRIPTION OF THE DRAWINGS

FIG. 1 is a diagram for describing a communication system according to a first embodiment;

FIG. 2 is a diagram illustrating an example of a configuration of the communication system according to the first embodiment;

FIG. 3 is a block diagram illustrating an example of a configuration of a management apparatus according to the first embodiment;

FIG. 4 is a block diagram illustrating an example of a configuration of a terminal device according to the first embodiment;

FIG. 5 is a flowchart illustrating content of a process performed by the management apparatus according to the first embodiment;

FIG. 6 is a flowchart illustrating content of a process performed by the terminal device according to the first embodiment;

FIG. 7 is a flowchart illustrating a flow of a slot division determination process according to a first example of the first embodiment;

FIG. 8 is a flowchart illustrating a flow of a slot division determination process according to a second example of the first embodiment;

FIG. 9 is a flowchart illustrating a flow of a slot division determination process according to a third example of the first embodiment;

FIG. 10 is a flowchart illustrating a flow of a slot division determination process according to a fourth example of the first embodiment;

FIG. 11 is a flowchart illustrating a flow of a slot division determination process according to a fifth example of the first embodiment;

FIG. 12 is a flowchart illustrating a flow of a slot division determination process according to a sixth example of the first embodiment;

FIG. 13 is a flowchart illustrating a flow of a slot division determination process according to a seventh example of the first embodiment;

FIG. 14 is a diagram for describing a communication system according to a second embodiment;

FIG. 15 is a block diagram illustrating an example of a configuration of a management apparatus according to the second embodiment;

FIG. 16 is a diagram for describing a method of dividing a slot according to the second embodiment;

FIG. 17 is a flowchart illustrating a flow of a process performed by the management apparatus according to the second embodiment; and

FIG. 18 is a diagram for describing a method of restoring a divided slot according to the second embodiment.

### DETAILED DESCRIPTION OF THE PREFERRED EMBODIMENTS

With reference to the accompanying drawings, embodiments of the present disclosure will be described in detail below. Note that the embodiments do not limit the present disclosure and, in the following embodiment, the same reference numerals are assigned to the same parts and thus redundant description will be omitted.

### Overview

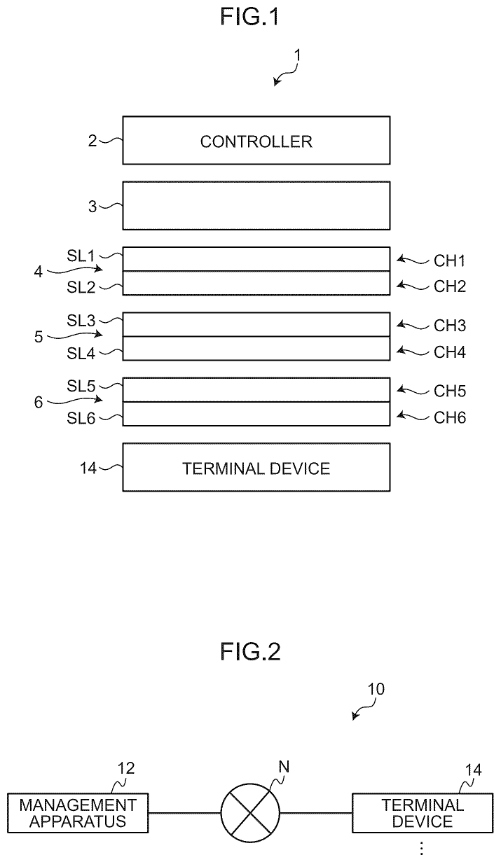

Using FIG. 1, a communication system according to a first embodiment will be described. FIG. 1 is a diagram for describing the communication system according to the first embodiment.

FIG. 1 illustrates, for example, an overview of a trunking system in the field of land mobile radio (LMR). A trunking system 1 includes, for example, a controller 2, a repeater 3, a repeater 4, a repeater 5, a repeater 6, and a terminal device 14. Assume that the repeater 3 is a repeater for a control channel. Assume that the repeaters 4 to 6 are repeaters for communication channels.

The controller 2 controls the repeaters 3 to 6 and manages the terminal device 14. The controller 2 senses a status of each slot of the repeaters 4 to 6 for communication channels in order to determine whether or not new communication is enabled.

The repeater 4 has two communication channels that are a channel CH1 and a channel CH2. The channel CH1 has a slot SL1. The channel CH2 has a slot SL2.

The repeater 5 has two communication channels that are a channel CH3 and a channel CH4. The channel CH3 has a slot SL3. The channel CH4 has a slot SL4.

The repeater 6 has two communication channels that are a channel CH5 and a channel CH6. The channel CH5 has a slot SL5. The channel CH6 has a slot SL6.

On sensing the terminal device 14 that has made a new communication connection request via the repeater 3, the controller 2 specifies a repeater with an empty slot among the repeaters 4 to 6. The controller 2 causes the repeater with an empty slot to manage the terminal device 14 having made a new communication request.

The repeater 4 manage channels in the slot SL1 and the slot SL2. The repeater 4 notifies the controller 2 of the statuses of the slot SL1 and the slot SL2. The repeater 5 manage channels in the slot SL3 and the slot SL4. The repeater 5 notifies the controller 2 of the statuses of the slot SL3 and the slot SL4. The repeater 6 manage channels in the slot SL5 and the slot SL6. The repeater 6 notifies the controller 2 of the statuses of the slot SL5 and the slot SL6.

In response to a request from the controller 2, the repeaters 4 to 6 allocate a slot that the terminal device 14 uses, establish a connection with the terminal device 14, and manage communication of the terminal device 14.

In a general trunking system, the controller 2 senses the terminal device 14 via the repeater 3 and, when it is determined that there is no empty slot in the repeaters 4 to 6, transmits a disconnection signal to the terminal device 14. In other words, when there is no empty slot in the repeaters 4 to 6, the terminal device 14 is unable to establish communication.

The communication system of the disclosure is a trunking system that enables handling by a TDMA (Time Division Multiple Access) system according to a connection status of the terminal device. Specifically, even when the channels are filled, the communication system of the disclosure performs control to lower an audio bit rate during communication to an extent that communication is not disturbed and divides a channel in communication into a slot in communication and an empty slot. The communication system of the disclosure is able to increase the number of simultaneous communications by allocating a new communication to the empty slot.

### First Embodiment

### Communication System

Using FIG. 2, an example of a configuration of the communication system according to the first embodiment will be described. FIG. 2 is a diagram illustrating the example of the configuration of the communication system according to the first embodiment.

As illustrated in FIG. 2, a communication system 10 includes a management apparatus 12 and a plurality of the terminal devices 14. The management apparatus 12 and the terminal devices 14 are connected such that the management apparatus 12 and the terminal devices 14 are able to communicate via a radio network N. The communication system 10 is a communication system in which the management apparatus 12 manages group communication between the terminal devices 14.

### Management Apparatus

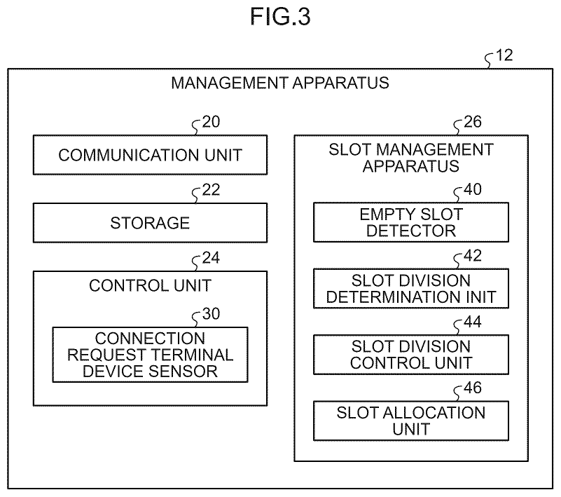

Using FIG. 3, an example of a configuration of a management apparatus according to the first embodiment will be described. FIG. 3 is a block diagram illustrating the example of the configuration of the management apparatus according to the first embodiment.

The management apparatus 12 includes a communication unit 20, a storage 22, a control unit 24, and a slot management unit 26. The management apparatus 12 is enabled with an information processing apparatus, such as a personal computer.

The management apparatus 12 enables the controller 2 and the repeaters 3 to 6 that are illustrated in FIG. 1. The control unit 24 enables the controller 2 and the repeater 3 for control channels. The slot management unit 26 enables the repeaters 4 to 6 for communication channels.

The communication unit 20 is a communication interface that establishes communication between the management apparatus 12 and an external device. The communication unit 20, for example, executes communication between the management apparatus 12 and the terminal device 14. The communication unit 20, for example, relays communication between the terminal devices 14. Communication of control information between the management apparatus 12 and the terminal device 14 may be established using a control channel of the communication unit 20. A slot for control is allocated to the control channel and communication of control information is established using the slot for control. The control information may be a disconnection signal such as a busy signal, an ACK/NACK signal that is a response to a request, a connection request signal from a terminal device that tries to make a connection request anew to be described below, an inquiry signal of an inquiry on whether or not a bit rate can be changed, or a bit rate change request signal. A call between the terminal devices 14 may be made via a call slot that is allocated as a communication channel of the communication unit 20 for a call. The communication unit 20, for example, is enabled with business radio, a wireless LAN (Local Area Network), Wi-Fi (trademark), or the like.

The storage 22 stores various types of information. The storage 22 stores content of arithmetic operations performed by the control unit 24 and the slot management unit 26 and information such as programs. The storage 22 includes, for example, at least any one of a RAM (Random Access Memory), a main storage device such as a ROM (Read Only Memory), and an external storage device such as a HDD (Hard Disk Drive). The storage 22 may store destination information on one-to-one individual communications or group information on group communication. The destination information or the group information are used to specify a terminal device serving as a communication partner and are used for communication, and thus the information may contain identification information that identifies each terminal device. The destination information or the group information may contain, or may be stored in association with, information on frequencies that are allocated to communicate with the respective terminal devices serving as communication partners and information on slots that are allocated. When each communication terminal device is connected via the Internet, the destination information or the group information may contain, or may be stored in association with, information for specifying a communication partner such as an IP address. The destination information or the group information may be stored in the storage 22 previously in order to make a setting on which of the terminal devices 14 the terminal device 14 is connected to or, when destination information and group information to be communicated are transmitted from the terminal device 14 that has made a connection request to the management apparatus 12, the destination information and the group information may be stored in the storage 22 anew.

The control unit 24 and the slot management unit 26 control each unit of the management apparatus 12. The control unit 24 and the slot management unit 26, for example, include an information processing device, such as a CPU (Central Processing Unit) or a MPU (Micro Processing Unit), and a storage device, such as a RAM or a ROM. The control unit 24 and the slot management unit 26 execute a program for controlling operations of the management apparatus 12 according to the disclosure. The control unit 24 and the slot management unit 26, for example, may be enabled with an integrated circuit such as an ASIC (Application specific integrated circuit) or a FPGA (Field Programmable Gate Array). The control unit 24 may be enabled with a combination of hardware and software.

The control unit 24 includes a connection request terminal device sensor 30.

The connection request terminal device sensor 30 receives a connection request signal indicating a connection request from the terminal device 14 via the communication unit 20. Based on the received connection request signal, the connection request terminal device sensor 30 specifies the terminal device 14 having made the connection request.

The slot management unit 26 manages slots tat the terminal device 14 uses in communication. The slots are divided into control slots used as channels for control and call slots used for calls. The call slots are sometimes referred to simply as slots below. The slot management unit 26 checks whether or not there is an empty slot in the call slots to be managed. When the terminal device 14 makes a connection request and there is an empty slot in the call slots that the slot management unit 26 manages, the slot management unit 26 allocates the specified empty slot to communication of the terminal device having made the connection request. When the terminal device 14 makes a connection request and there is no empty slot in the call slots that the slot management unit 26 manages, the slot management unit 26 specifies a slot that is in use for a call (“in-use slot” below) and that is to be divided (“division subject slot” below) in in-use slots. When it is determined that the division subject slot is dividable, the slot management unit 26 performs a division process on the division subject slot and allocates an empty slot after the division to communication of the terminal device 14 having made the connection request.

The slot management unit 26 includes an empty slot detector 40, a slot division determination unit 42, a slot division control unit 44, and a slot allocation unit 46.

The empty slot detector 40 detects whether or not there is an empty slot in a plurality of call slots that the slot management unit 26 manages.

When there is no empty slot in the call slots that the slot management unit 26 manages, the slot division determination unit 42 specifies an in-use slot to which an inquiry is to be made (“inquiry subject slot” below). The terminal device 14 that is using the inquiry subject slot is referred to as an in-use terminal device in some cases. The slot division determination unit 42 makes an inquiry on whether or not a bit rate is changeable to the in-use terminal device that is using the inquiry subject slot. Based on a response that the bit rate is changeable from the in-use terminal device, the slot division determination unit 42 specifies the inquiry subject slot that the in-use terminal device is using as a dividable slot. Here, as for the in-use terminal device that is using the inquiry subject slot, when communication using the in-use slot is a group call, the transmitting terminal device 14 and at least two receiving terminal devices 14 are in-use terminal devices. When communication that is using the in-use slot is a normal one-to-one individual call, the transmitting terminal device 14 and the receiving terminal device 14 are in-use-terminal devices.

When the number of in-use terminal devices that have responded that the bit rate is changeable in the in-use terminal devices meets a given condition, the slot division determination unit 42 may determine that the inquiry subject slot is a dividable slot. The given condition may be, for example, that the number of in-use terminal devices that have responded that the bit rate is changeable is a given number. The given condition may be, for example, the number of in-use terminal devices that have responded that the bit rate is changeable, which is the number set such that the number changes according to the number of the in-use terminal devices. For example, a given proportion may be set and the condition may be that the given proportion of the number of in-use terminal devices is the number of the in-use terminal devices having responded that the bit rate is changeable. When the inquiry subject slot is used for a call of a group consisting of a plurality of terminal devices including the transmitting terminal device 14 and at least two receiving terminal devices 14, the slot division determination unit 42 determines that the terminal devices 14 that include the transmitting terminal device 14 and the at least two receiving terminal devices 14 and that make the group call using the in-use slot are the in-use terminal devices and makes an inquiry on whether or not the bit rate is changeable to the terminal devices 14. When the transmitting terminal device and the at least two receiving terminal devices in the in-use terminal devices respond that the bit rate is changeable, the slot division determination unit 42 determines that the slot is a slot that is dividable. The slot that is dividable is sometimes referred to as a dividable slot.

The slot division control unit 44 transmits a bit rate change request signal representing an instruction to change the bit rate to the in-use terminal devices using the dividable slot via the communication unit 20. The slot division control unit 44 performs the division process on the dividable slot while transmitting a bit rate change request signal to the terminal devices 14.

The slot allocation unit 46 allocates the in-use terminal device and the terminal device having made the connection request to divided slots. The dividable slot is allocated and accordingly the terminal devices 14 enter a state where communication can be established.

### Terminal Device

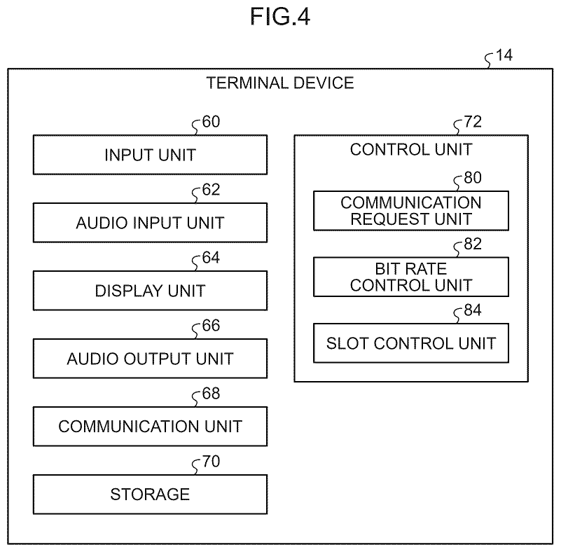

Using FIG. 4, an example of a configuration of the terminal device according to the first embodiment will be described. FIG. 4 is a block diagram illustrating the example of the configuration of the terminal device according to the first embodiment.

As illustrated in FIG. 4, the terminal device 14 includes an input unit 60, an audio input unit 62, a display unit 64, an audio output unit 66, a communication unit 68, a storage 70, and a control unit 72. The terminal device 14 is, for example, a business radio communication apparatus, a mobile phone, a smartphone, or a tablet terminal device; however, the terminal device 14 is not limited to them.

The input unit 60 receives various types of operations on the terminal device 14. The input unit 60, for example, is enabled with various types of input devices such as a switch, a button, and a touch panel.

The audio input unit 62 detects voice of a user who uses the terminal device 14. The audio input unit 62 converts the detected voice into an audio signal. The audio input unit 62 is enabled with a microphone.

The display unit 64 displays various types of information. The display unit 64, for example, is enabled with a display containing a liquid crystal display or an EL (Electro-Luminescence) display.

The audio output unit 66 is a speaker that outputs various types of sound. The audio output unit 66, for example, outputs voice of a communication partner.

The communication unit 68 is a communication interface that establishes communication between the terminal device 14 and an external device. The communication unit 68, for example, executes communication between the terminal device 14 and the management apparatus 12.

The storage 70 stores various types of information. The storage 70 stores content of arithmetic operations performed by the control unit 72 and information such as programs. The storage 70 includes, for example, at least any one of a RAM, a main storage device such as a ROM, and an external storage device such as a HDD.

The control unit 72 controls each unit of the terminal device 14. The control unit 72, for example, includes an information processing device, such as a CPU or a MPU, and a storage device, such as a RAM or a ROM. The control unit 72 executes a program for controlling operations of the terminal device 14 according to the disclosure. The control unit 72, for example, may be enabled with an integrated circuit such as an ASIC or a FPGA. The control unit 72 may be enabled with a combination of hardware and software.

The control unit 72 includes a communication request unit 80, a bit rate control unit 82, and a slot control unit 84.

When the terminal device 14 tries to establish communication, the communication request unit 80 transmits a connection request signal indicating a connection request to the management apparatus 12 via the communication unit 68.

The bit rate control unit 82 changes a bit rate of a communication signal that the terminal device 14 transmits. The bit rate control unit 82, for example, changes a bit rate of an audio signal that the terminal device 14 transmits. When a bit rate change request signal is received from the management apparatus 12, the bit rate control unit 82 changes the bit rate of the audio signal based on the received bit rate change request signal. On changing the bit rate, the bit rate control unit 82 transmits a response signal indicating the change to the management apparatus 12.

The slot control unit 84 is connected to a slot that is allocated by the management apparatus 12. The slot control unit 84 is connected to the slot allocated by the management apparatus 12 and executes communication.

### Process performed by Management Apparatus

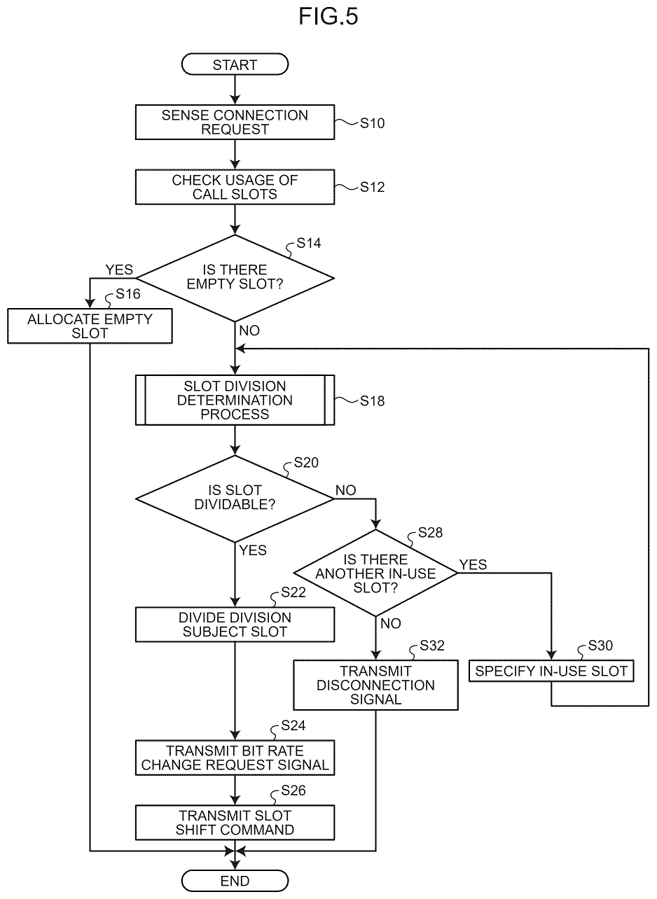

Using FIG. 5, content of a process performed by the management apparatus according to the first embodiment will be described. FIG. 5 is a flowchart illustrating the content of the process performed by the management apparatus according to the first embodiment.

The connection request terminal device sensor 30 senses a connection request from the terminal device 14 (step S10). Specifically, on receiving a connection request signal from the terminal device 14, the connection request terminal device sensor 30 senses the connection request from the terminal device 14. Then, go to step S12.

The empty slot detector 40 checks usage of the call slots (step S12). Then, go to step S14.

The empty slot detector 40 determines whether or not there is an empty slot in the call slots (step S14). When it is determined that there is an empty slot in the call slots (Yes at step S14), go to step S16. When it is not determined that there is an empty slot in the call slots (No at step S14), go to step S18.

When Yes is determined at step S14, the slot allocation unit 46 allocates the empty slot to the terminal device 14 having made the connection request (step S16). Then, end the process in FIG. 5.

When No is determined at step S14, the slot management unit 26 executes a slot division determination process for determining whether or not an in-use slot is dividable (step S18). There is no empty slot in the slots and therefore the slot management unit 26 specifies an inquiry subject slot from the slots in use for calls. Thereafter, the slot management unit 26 specifies the terminal devices 14 that are using the specified inquiry subject slot. In order to specify the terminal devices 14 that are using the specified inquiry subject slot, the slot management unit 26 may make an inquiry on allocation of the terminal devices 14 to slots to the slot allocation unit 46 and specify the terminal devices 14. The storage 22 may store destination information on a one-to-one individual call allocated to the in-use slot or group information on a group call. In this case, when specifying the terminal devices 14 that are using the inquiry subject slot, the slot management unit 26 may read the destination information or the group information on a call using the inquiry subject slot from the storage 22 of the management apparatus and specify the terminal devices 14. The slot division determination unit 42, for example, makes an inquiry on whether or not the bit rate is changeable to the specified terminal devices 14 and, based on responses from the terminal devices 14, determines whether or not the slot is dividable. Details of the slot division determination process will be described below. Then, go to step S20.

The slot division determination unit 42 determines whether or not the in-use slot is dividable (step S20). When it is determined that the in-use slot is dividable (Yes at step S20), go to step S22. When it is not determined that the in-use slot is dividable (No at step S20), go to step S28.

When Yes is determined at step S20, the slot division control unit 44 divides a division subject slot (step S22). Then, go to step S24.

The slot division control unit 44 transmits a bit rate change request signal to the terminal device 14 having made the connection request (step S24). Then, go to step S26.

The slot allocation unit 46 transmits a slot shift command to the terminal device 14 having made the connection request and allocates the terminal device 14 to an empty slot obtained by dividing the division subject slot (step S26). Accordingly, the terminal device 14 is able to establish communication. Then, end the process in FIG. 5.

When No is determined at step S20, the empty slot detector 40 determines whether or not there is another in-use slot (step S28). When it is determined that there is another in-use slot (Yes at step S28), go to step S30. When it is not determined that there is another in-use slot (No at step S28), go to step S32.

When Yes is determined at step S28, the empty slot detector 40 specifies another in-use slot (step S30). Then, go to step S18 and repeat the same process.

When No is determined at step S28, the control unit 24 transmits a disconnection signal to the terminal device 14 having made the connection request (step S32). Accordingly, communication between the management apparatus 12 and the terminal device 14 is disconnected. Then, end the process in FIG. 5.

### Process Performed by Terminal Device

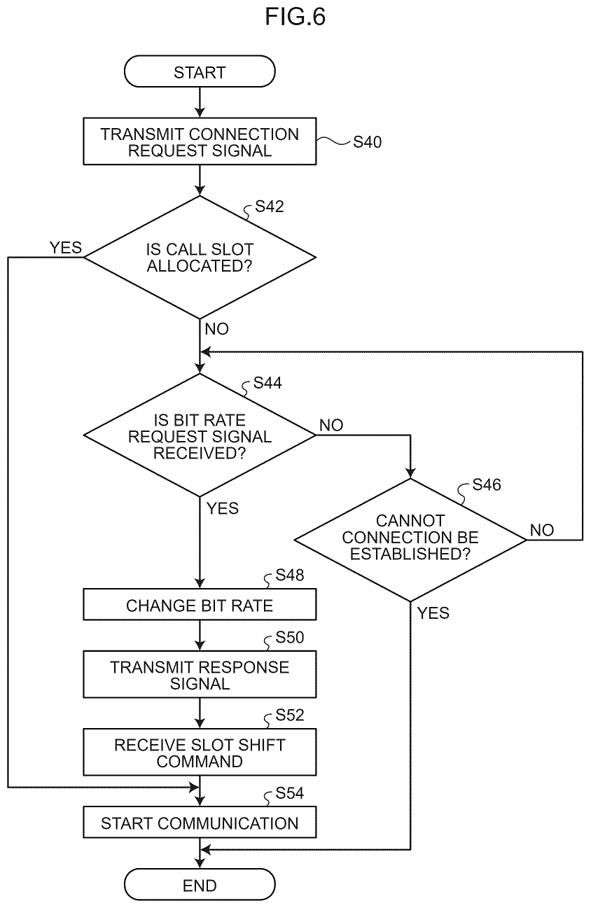

Using FIG. 6, content of a process performed by the terminal device according to the first embodiment will be described. FIG. 6 is a flowchart illustrating the content of the process performed by the terminal device according to the first embodiment.

The communication request unit 80 transmits a connection request signal to the management apparatus 12 (step S40). Then, go to step S42.

The control unit 72 determines whether or not a call slot is allocated from the management apparatus 12 (step S42). When it is determined that a call slot is allocated (Yes at step S42), go to step S54. When it is not determined that a call slot is allocated (No at step S42), go to step S44.

When No is determined at step S42, the control unit 72 determines whether or not a bit rate change request signal is received from the management apparatus 12 (step S44). When it is determined that a bit rate change request signal is received (Yes at step S44), go to step S48. When it is not determined that a bit rate change request signal is received (No at step S44), go to step S46.

When No is determined at step S44, the control unit 72 determines whether or not a connection cannot be established (step S46). For example, the control unit 72 determines that a connection cannot be established when a disconnection signal is received from the management apparatus 12 or when a slot is not allocated or a bit rate change request signal cannot be received for a given time or more after transmission of the connection request signal. When it is determined that a connection cannot be established (Yes at step S46), end the process in FIG. 6. When it is not determined that a connection cannot be established (No at step S46), return to step S44 and repeat the process.

When Yes is determined at step S44, the bit rate control unit 82 changes a bit rate when transmitting an audio signal (step S48). Then, go to step S50.

The bit rate control unit 82 transmits a response signal indicating that the bit rate has been changed to the management apparatus 12 (step S50). Then, go to step S52.

The slot control unit 84 receives a slot shift command from the management apparatus 12 (step S52). Accordingly, the slot is allocated to the terminal device 14. Then, go to step S54.

When Yes is determined at step S42, or after step S52, the control unit 72 starts communication (step S54). Then, end the process in FIG. 6.

### Slot Division Determination Process

The slot division determination process will be described next. In the slot division determination process, an in-use slot that meets a given condition based on the number of the terminal devices 14 that are using an in-use slot is determined as an inquiry subject slot and a process is executed. Here, the given condition for determining a slot as an inquiry subject slot may include, for example, when selecting an inquiry subject slot from in-use slots, lowering priority of in-use slots that are used for group calls and selecting an inquiry subject slot. In other words, when selecting an inquiry subject slot, the slot division determination unit may select an inquiry subject slot in a way that priority of selecting a call slot that is used for a group call is lowered. The given condition for determining a slot as an inquiry subject slot may include, for example, in the case where all the in-use slots are for group calls when selecting an inquiry subject slot from the in-use slots, selecting an inquiry subject slot according to an ascending order in the number of in-use terminal devices belonging to a group call. The given condition for determining a call as an inquiry subject slot may include, for example, when selecting an inquiry subject slot from the in-use slots, selecting inquiry subject slot according to an ascending order in the frequency of calling or a duration of calling in a given period in the in-use slot.

### First Example of Slot Division Determination Process

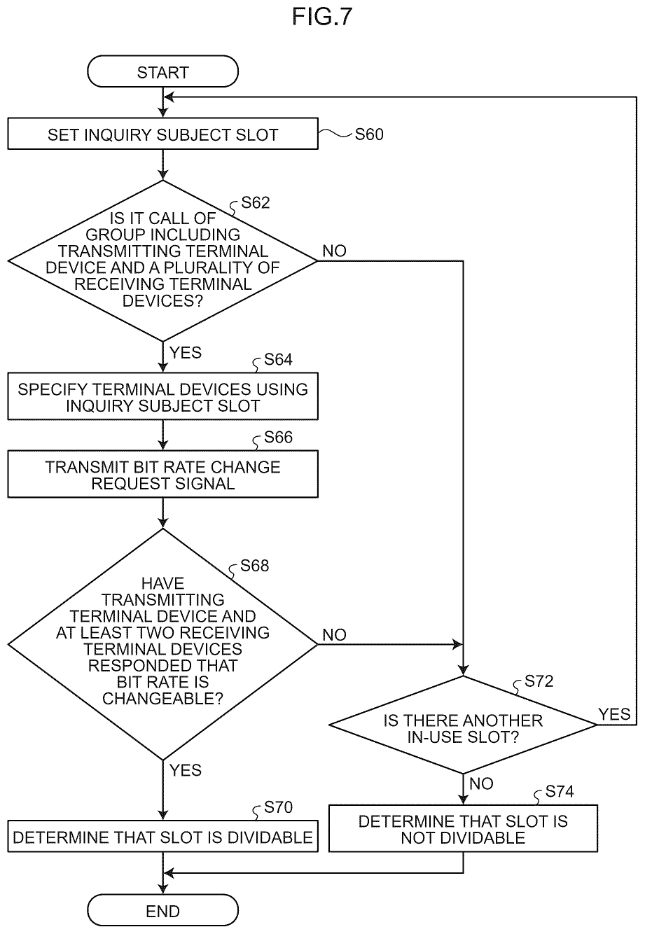

Using FIG. 7, a slot division determination process according to a first example of the first embodiment will be described. FIG. 7 is a flowchart illustrating a flow of the slot division determination process according to the first example of the first embodiment.

The slot division determination unit 42 sets an inquiry subject slot among the in-use slots (step S60). Then, go to step S62.

The slot division determination unit 42 determines whether or not communication using the inquiry subject slot is a call of a group including the transmitting terminal device 14 and a plurality of the receiving terminal devices 14 (step S62). Here, the slot division determination unit 42, for example, may determine whether or not the communication is a call of a group including the transmitting terminal device 14 and a plurality of the receiving terminal devices 14 by acquiring information on the terminal devices 14 that are allocated to the inquiry subject slot from the slot allocation unit 46. When it is determined that the communication is a call of a group including the transmitting terminal device 14 and a plurality of the receiving terminal devices 14 (Yes at step S62), go to step S64. When it is not determined that the communication is a call of a group including the transmitting terminal device 14 and a plurality of the receiving terminal devices 14 (No at step S62), go to step S72.

When Yes is determined at step S62, the slot division determination unit 42 specifies the terminal devices 14 that are using the inquiry subject slot (step S64). The slot division determination unit 42, for example, may specify the transmitting terminal device 14 and the receiving terminal devices 14 by acquiring information on the terminal devices 14 that are allocated to the inquiry subject slot from the slot allocation unit 46. In this case, the slot allocation unit 46 specifies which terminal devices 14 are allocated to the inquiry subject slot and notifies the slot division determination unit 42 of the information on the terminal devices 14 that are allocated to the inquiry subject slot. When determining whether or not the communication is a group call, the slot division determination unit 42 may read the destination information or the group information on a call using the inquiry subject slot from the storage 22 and specify the terminal devices 14 who are participating in the call. Then, go to step S66.

The slot division determination unit 42 transmits a bit rate change request signal to the terminal devices 14 (step S66). Then, go to step S68.

The slot division determination unit 42 determines whether or not the transmitting terminal device 14 and at least two receiving terminal devices 14 have responded that the bit rate is changeable (step S68). When it is determined that the transmitting terminal device 14 and at least two receiving terminal devices 14 have responded that the bit rate is changeable (Yes at step S68), go to step S70. When it is not determined that the transmitting terminal device 14 and at least two receiving terminal devices 14 have responded that the bit rate is changeable (No at step S68), go to step S72.

When Yes is determined at step S68, the slot division determination unit 42 determines that the slot is dividable (step S70). Then, end the process in FIG. 7.

When No is determined at step S62 or No is determined at step S68, the slot division determination unit 42 determines whether or not there is another in-use slot (step S72). When it is determined that there is another in-use slot (Yes at step S72), return to S60 and repeat the process. When it is not determined that there is another in-use slot (No at step S72), go to S74.

When No is determined at step S72, the slot division determination unit 42 determines that the slot is not dividable (step S74). Then, end the process in FIG. 7.

### Second Example of Slot Division Determination Process

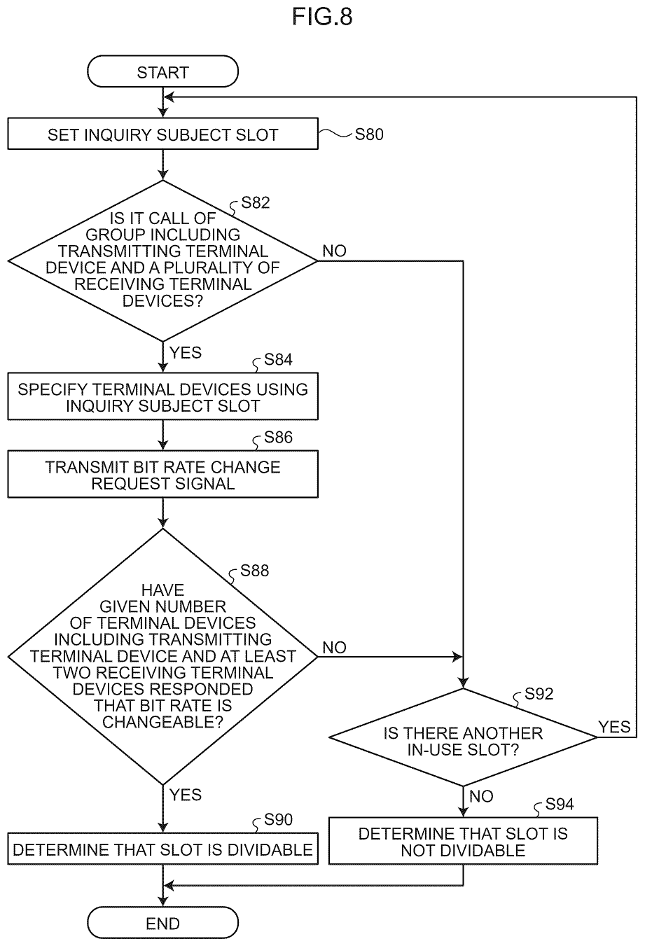

Using FIG. 8, a slot division determination process according to a second example of the first embodiment will be described. FIG. 8 is a flowchart illustrating a flow of the slot division determination process according to the second example of the first embodiment.

The processes of steps S80 to S86 and steps S90 to S94 are the same as the processes of steps S60 to S66 and steps S70 to S74 illustrated in FIG. 7, respectively, and thus description thereof will be omitted.

After step S86, the slot division determination unit 42 determines whether or not the number of in-use terminal devices that have responded that the bit rate is changeable meets the given condition. Here, as for the given condition, it is determined whether or not the given number of the terminal devices 14 including the transmitting terminal device 14 and at least two receiving terminal devices 14 have responded that the bit rate is changeable (step S88). The given number may be the number of all the terminal devices participating in the group call or may be any number. When it is determined that the given number of the terminal devices 14 including the transmitting terminal device 14 and at least two receiving terminal devices 14 have responded that the bit rate is changeable (Yes at step S88), go to step S90. When it is not determined that the given number of the terminal devices 14 including the transmitting terminal device 14 and at least two receiving terminal devices 14 have responded that the bit rate is changeable (No at step S88), go to step S92.

### Third Example of Slot Division Determination Process

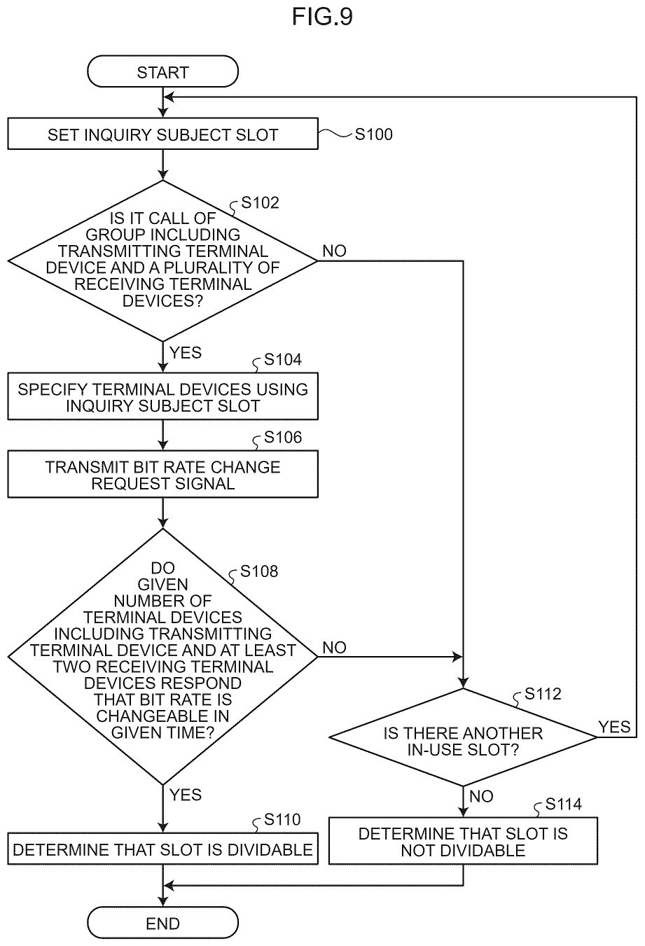

Using FIG. 9, a slot division determination process according to a third example of the first embodiment will be described. FIG. 9 is a flowchart illustrating a flow of the slot division determination process according to the third example of the first embodiment.

The processes of steps S100 to S106 and steps S110 to S114 are the same as the processes of steps S60 to S66 and steps S70 to S74 illustrated in FIG. 7, respectively, and thus description thereof will be omitted.

After step S106, the slot division determination unit 42 determines whether or not a given number of the terminal devices 14 including the transmitting terminal device 14 and at least two receiving terminal devices 14 respond that the bit rate is changeable in a given time (step S108). The given time is, for example, one second or shorter; however, the given time is not limited to this. The given time may be, for example, approximately one to two seconds. When it is determined that the given number of the terminal devices 14 including the transmitting terminal device 14 and at least two receiving terminal devices 14 respond that the bit rate is changeable in the given time (Yes at step S108), go to step S110. When it is not determined that the given number of the terminal devices 14 including the transmitting terminal device 14 and at least two receiving terminal devices 14 respond that the bit rate is changeable in the given time (No at step S108), go to step S112.

### Fourth Example of Slot Division Determination Process

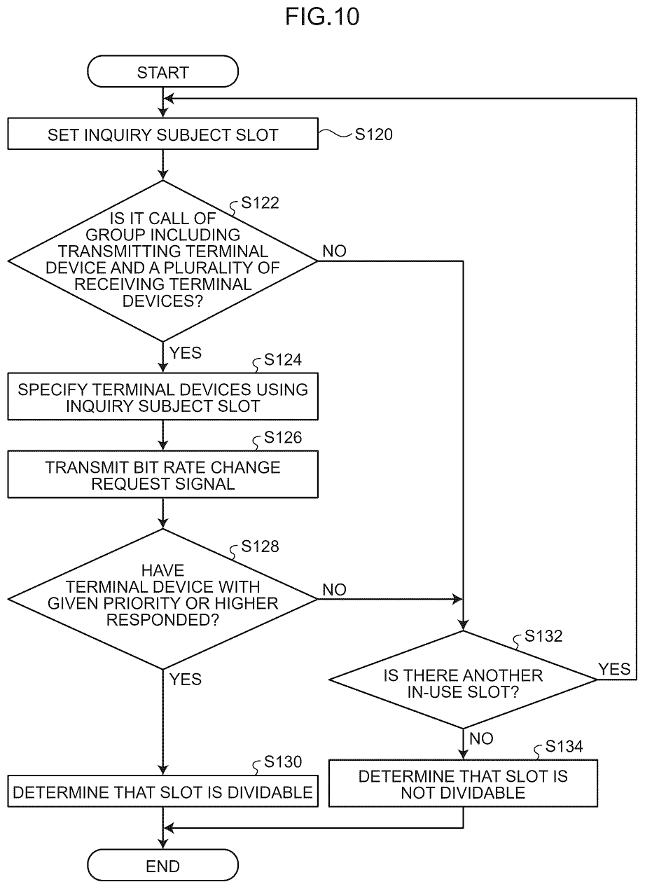

Using FIG. 10, a slot division determination process according to a fourth example of the first embodiment will be described. FIG. 10 is a flowchart illustrating a flow of the slot division determination process according to the fourth example of the first embodiment.

The processes of steps S120 to S126 and steps S130 to S134 are the same as the processes of steps S60 to S66 and steps S70 to S74 illustrated in FIG. 7, respectively, and thus description thereof will be omitted.

After step S126, the slot division determination unit 42 determines whether or not the terminal device 14 with given priority or higher has responded that the bit rate is changeable (step S128). The priority may be set freely previously. For example, the priority of the terminal device 14 that a specific user uses may be set high. For example, the priority of the terminal device 14 that a user in a high-ranking position uses may be set high. When it is determined that the terminal device 14 with the given priority or higher has responded that the bit rate is changeable (Yes at step S128), go to step S130. When it is not determined that the terminal device 14 with the given priority or higher has responded that the bit rate is changeable (No at step S128), go to step S132.

### Fifth Example of Slot Division Determination Process

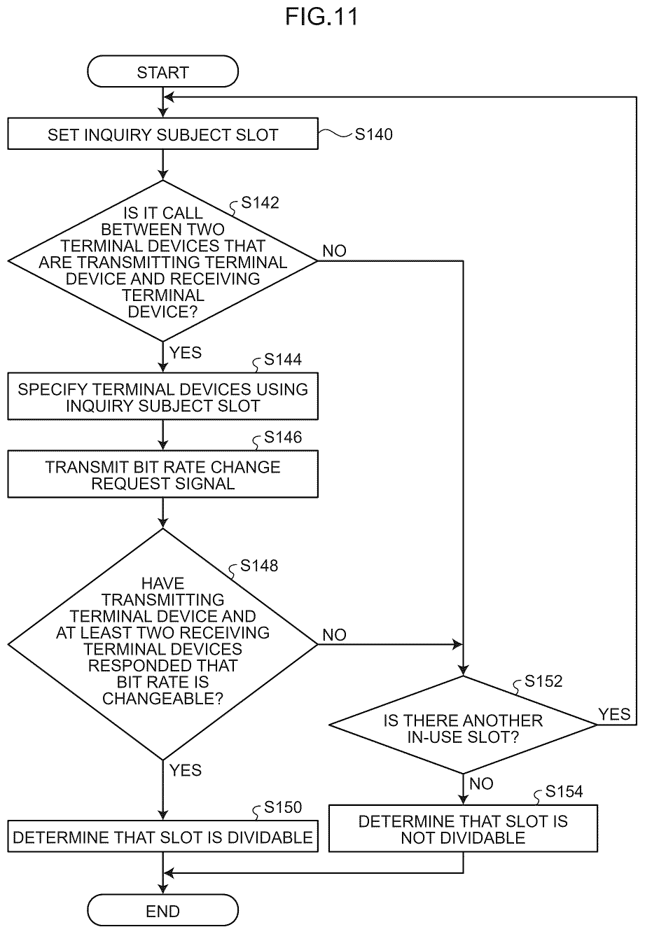

Using FIG. 11, a slot division determination process according to a fifth example of the first embodiment will be described. FIG. 11 is a flowchart illustrating a flow of the slot division determination process according to the fifth example of the first embodiment.

The process of step S140 is the same as the process of step S60 illustrated in FIG. 7 and thus description thereof will be omitted. The processes of steps S144 to S148 are the same as the processes of steps S64 to S68 illustrated in FIG. 7, respectively, and thus description thereof will be omitted. The processes of steps S150 to S154 are the same as the processes of steps S70 to S74 illustrated in FIG. 7, respectively, and thus description thereof will be omitted.

After step S140, the slot division determination unit 42 determines whether or not communication using the inquiry subject slot is a call between two terminal devices 14 that are the transmitting terminal device 14 and the receiving terminal device 14 (step S142). When it is determined that the communication is a call between two terminal devices 14 that are the transmitting terminal device 14 and the receiving terminal device 14 (Yes at step S142), go to step S144. When it is not determined that the communication is a call between two terminal devices 14 that are the transmitting terminal device 14 and the receiving terminal device 14 (No at step S142), go to step S152.

### Sixth Example of Slot Division Determination Process

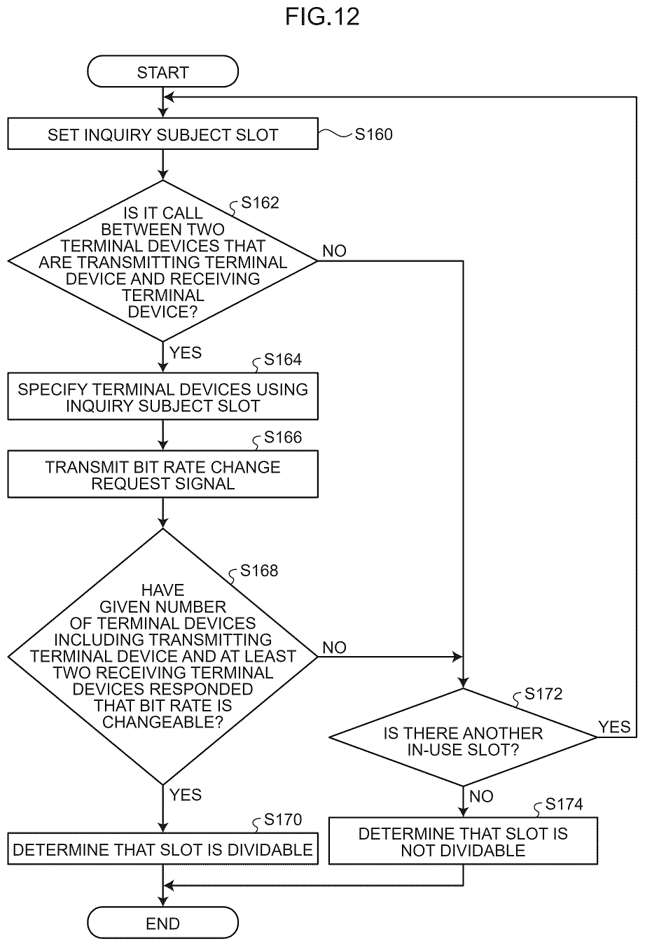

Using FIG. 12, a slot division determination process according to a sixth example of the first embodiment will be described. FIG. 12 is a flowchart illustrating a flow of the slot division determination process according to the sixth example of the first embodiment.

The processes of steps S160 to S166 and steps S170 to S174 are the same as the processes of steps S140 to S146 and steps S150 to S154 illustrated in FIG. 11, respectively, and thus description thereof will be omitted. The process of step S168 is the same as the process of step S88 illustrated in FIG. 8 and thus description thereof will be omitted.

In other words, the sixth example of the slot division determination process is a combination of the second example of the slot division determination process and the fifth example of the slot division determination process.

### Seventh Example of Slot Division Determination Process

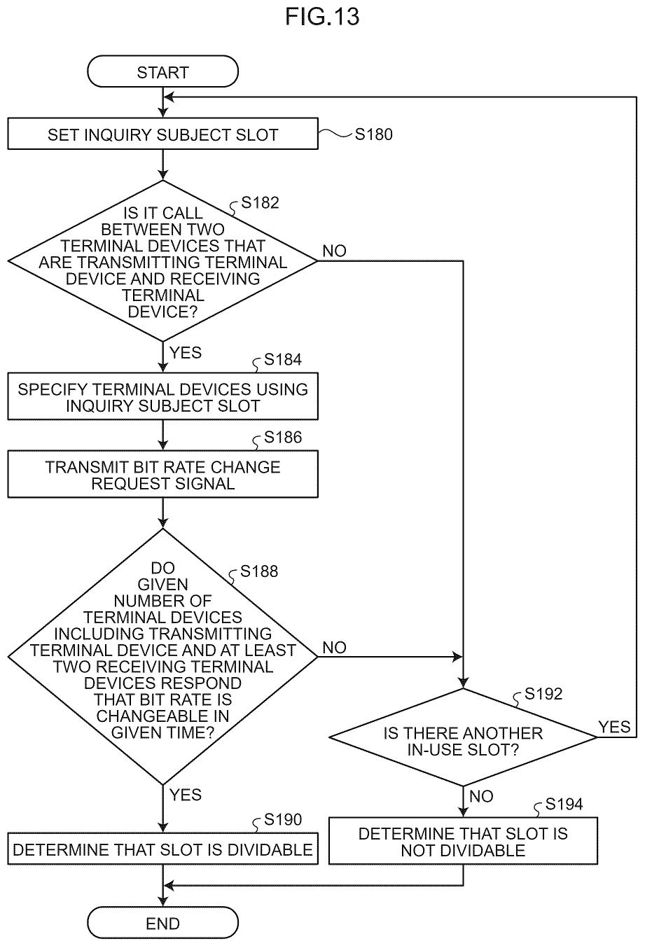

Using FIG. 13, a slot division determination process according to a seventh example of the first embodiment will be described. FIG. 13 is a flowchart illustrating a flow of the slot division determination process according to the seventh example of the first embodiment.

The processes of steps S180 to S186 and steps S190 to S194 are the same as the processes of steps S140 to S146 and steps S150 to S154 illustrated in FIG. 11, respectively, and thus description thereof will be omitted. The process of step S168 is the same as the process of step S108 illustrated in FIG. 9 and thus description thereof will be omitted.

In other words, the seventh example of the slot division determination process is a combination of the third example of the slot division determination process and the fifth example of the slot division determination process.

As described above, in the first embodiment, in the case where a terminal device makes a new connection request when a slot is in use for group communication, an inquiry on whether or not a bit rate is changeable is made to each terminal device. In the first embodiment, the slot is divided when a given terminal device responds that the bit rate is changeable and the divided slots are allocated to each terminal device. Accordingly, the first embodiment makes it possible to divide the slot appropriately and enable an uninterrupted group call.

### Second Embodiment

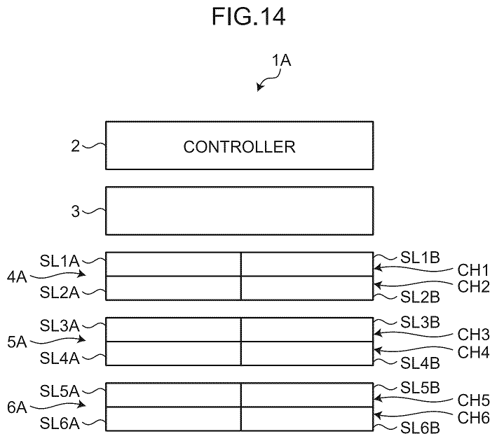

Using FIG. 14, a communication system according to a second embodiment will be described. FIG. 14 is a diagram for describing the communication system according to the second embodiment.

A trunking system 1A according to a second embodiment includes, for example, the controller 2, the repeater 3, a repeater 4A, a repeater 5A, a repeater 6A, and the terminal device 14.

The repeater 4A has two communication channels that are a channel CH1 and a channel CH2. The channel CH1 has a slot SL1A and a slot SL1B. The channel CH2 has a slot SL2A and a slot SL2B.

The repeater 5A has two communication channels that are a channel CH3 and a channel CH4. The channel CH3 has a slot SL3A and a slot SL3B. The channel CH4 has a slot SL4A and a slot SL4B.

The repeater 6A has two communication channels that are a channel CH5 and a channel CH6. The channel CH5 has a slot SL5A and a slot SL5B. The channel CH6 has a slot SL6A and a slot SL6B.

In other words, in the second embodiment, each of the communication channels of the repeaters 4A to 6A has two slots. Note that the number of slots that each communication channel has is not limited to two. This communication channel is used for calling and the slots that the communication channel has are call slots.

In the second embodiment, it is determined whether or not the number of calls is extensible based on the status of the slots that each of the repeaters manages and responses from the terminal devices 14.

### Management Apparatus

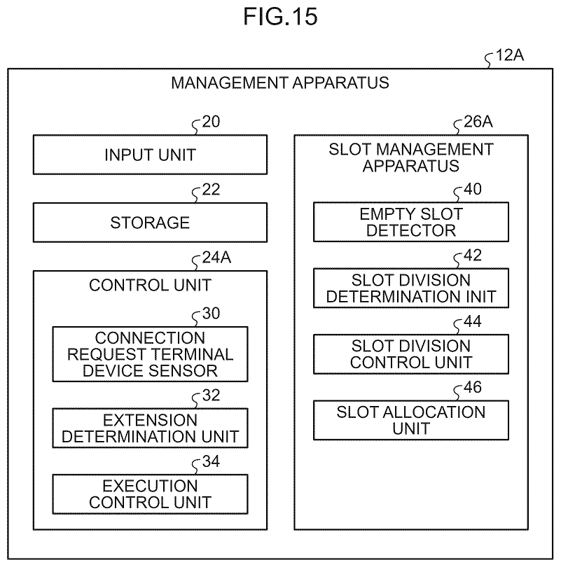

Using FIG. 15, an example of a configuration of a management apparatus according to the second embodiment will be described. FIG. 15 is a block diagram illustrating the example of the configuration of the management apparatus according to the second embodiment.

As illustrated in FIG. 15, a management apparatus 12A is different from the management apparatus 12 illustrated in FIG. 3 in that a control unit 24A includes an extension determination unit 32 and an execution control unit 34.

Based on the status of the slots that each of the repeaters manages and responses from the terminal devices 14, the extension determination unit 32 determines whether or not the number of calls is extensible.

When the extension determination unit 32 determines extension of the number of calls, the execution control unit 34 executes a call extension process.

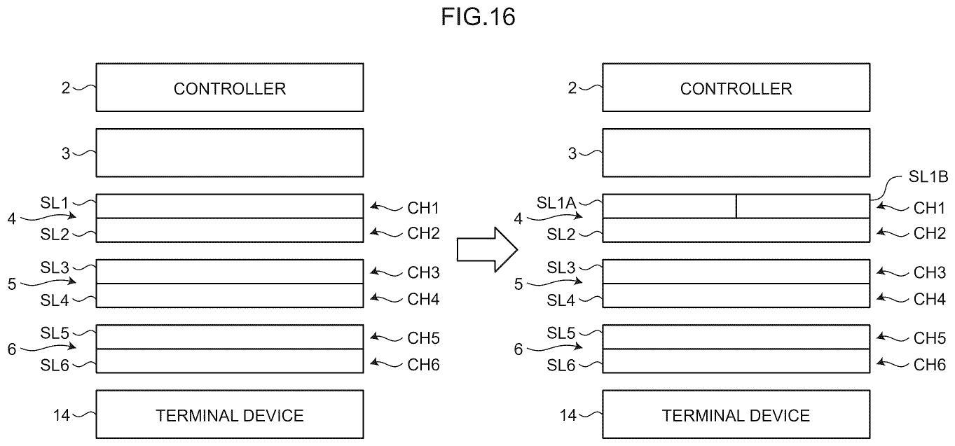

Using FIG. 16, a method of dividing a slot according to the second embodiment will be described. FIG. 16 is a diagram for describing the method of dividing a slot according to the second embodiment.

Assume that the repeater 4 establishes a first communication by using the slot SL1 for the channel CH1. Assume that the repeater 4 establishes a second communication by using the slot SL2 for the channel CH2.

Assume that the repeater 5 establishes a third communication by using the slot SL3 for the channel CH3. Assume that the repeater 5 establishes a fourth communication by using the slot SL4 for the channel CH4.

Assume that the repeater 6 establishes a fifth communication by using the slot SL5 for the channel CH5. Assume that the repeater 6 establishes a sixth communication by using the slot SL6 for the channel CH6.

Assume that the connection request terminal device sensor 30 senses a new seventh communication in a state where all the slots of each repeater are used. in this case, the slot division determination unit 42 determines whether or not there is a dividable slot among the slots SL1 to SL6 of the repeaters 4 to 6. For example, when the slot division determination unit 42 determines that the slot L1 of the repeater 4 is dividable, the slot division control unit 44 divides the slot SL1 into the slot SL1A and the slot SL1B. The slot allocation unit 46 allocates the seventh communication to the slot SL1B obtained by the division by the slot division control unit 44. In this case, the first communication is executed by using the slot SL1A. Note that, in the example illustrated in FIG. 16, the example where one slot is divided into two slots is described; however, the disclosure is not limited to this. According to the disclosure, one slot may be divided into three slots or more. The bit rate lowers as the number of slots into which one slot is divided increases and therefore, according to the disclosure, the number of slots into which a slot is divided may be determined within a range where communication quality is acceptable.

### Process Performed by Management Apparatus

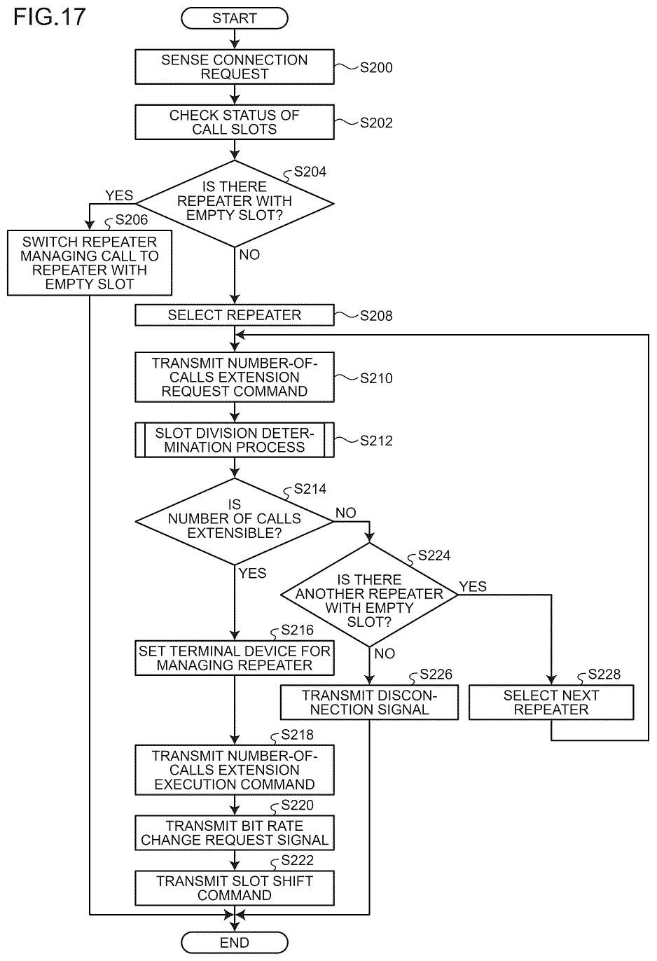

Using FIG. 17, a process performed by the management apparatus according to the second embodiment will be described. FIG. 17 is a flowchart illustrating a flow of the process performed by the management apparatus according to the second embodiment.

The process of step S200 is the same as the process of step S10 illustrated in FIG. 5 and thus description thereof will be omitted.

The empty slot detector 40 checks usage of the call slots of each repeater (step S202). Then, go to step S204.

The empty slot detector 40 determines whether or not it is a repeater with an empty slot in the call slots (step S204). When it is determined that there is a repeater with an empty slot in the call slots (Yes at step S204), go to step S206. When it is not determined that there is a repeater with an empty slot in the call slots (No at step S204), go to step S208.

When Yes is determined at step S204, a slot management unit 26A switches the repeater that manages calls to a repeater with the empty slot (step S206). Then, end the process in FIG. 17.

When No is determined at step S204, the slot management unit 26A selects a repeater to which a request to extend the number of calls is made (step S208). Then, go to step S208.

The slot management unit 26A transmits a number-of-calls extension command for causing the selected repeater to divide the slot (step S210). Then, go to step S212.

The slot management unit 26A executes a slot division determination process for determining whether or not an in-use slot is dividable in the repeater to which a number-of-calls extension request command is transmitted (step S212). Details of the slot division determination process is the same as that of the first embodiment and thus description thereof will be omitted.

The slot division determination unit 42 determines whether or not the number of calls is extensible by dividing the in-use slot (step S214). When it is determined that the number of calls is extensible (Yes at step S214), go to step S216. When it is not determined that the number of calls is extensible (No at step S214), go to step S224.

When Yes is determined at step S214, the slot management unit 26A sets the terminal device on which it is determined that the number of calls is extensible for a repeater that manages the terminal device 14 having made a new connection request (step S216). Then, go to step S218.

The slot division control unit 44 transmits a number-of-calls extension request execution command to the repeater that manages the terminal device 14 having made the connection request to divide the slot (step S218). Then, go to step S220.

The slot division control unit 44 transmits a bit rate change request signal to the terminal device 14 having made the connection request (step S220). Then, go to step S222.

The slot allocation unit 46 transmits a slot shift command to the terminal device 14 having made the connection request and allocates the terminal device 14 to an empty slot obtained by the division (step S222). Accordingly, the terminal device 14 is able to establish communication. Then, end the process in FIG. 17.

When No is determined at step S224, the empty slot detector 40 determines whether or not there is another repeater with an empty slot (step S224). When it is determined that there is another repeater with an empty slot (Yes at step S224), go to step S228. When it is not determined that there is another repeater with an empty slot (No at step S224), go to step S226.

When No is determined at step S224, the control unit 24 transmits a disconnection signal to the terminal device 14 having made the connection request (step S226). Accordingly, communication between the management apparatus 12 and the terminal device 14 is disconnected. Then, end the process in FIG. 17.

When Yes is determined at step S224, the slot management unit 26A selects the next repeater to which a request to extend the number of calls is made (step S228). Then, go to step S210.

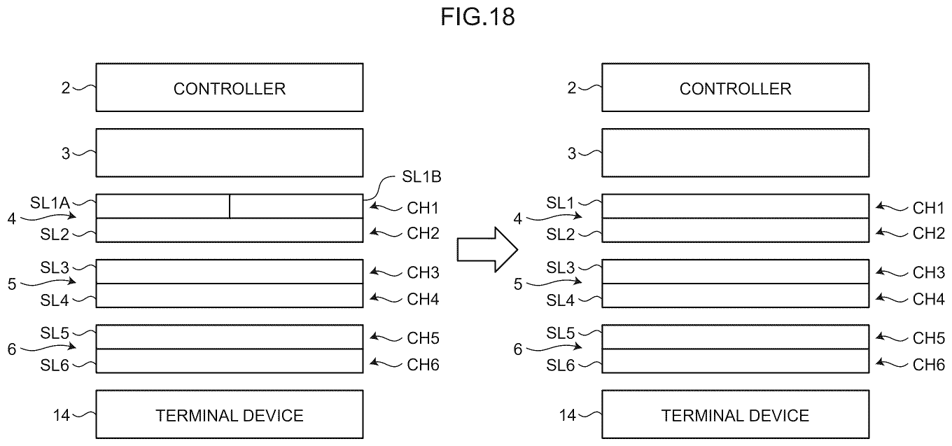

Using FIG. 18, a method of restoring a divided slot according to the second embodiment will be described. FIG. 18 is a diagram for describing the method of restoring a dividing a slot according to the second embodiment.

Assume that the seventh communication is established using the slot SL1B of the repeater 4. Here, on sensing the seventh communication, the controller 2 transmits a number-of-calls extension request command for changing the number of slots of the channel CH1 to 1 to the repeater 4.

The repeater 2 transmits a number-of-calls extension request command for changing the number of slots to 1 to the terminal device 14 establishing the first communication using the slot SL1A.

When a change to the original communication system and the original audio bit rate can be made, the terminal device 14 establishing the first communication transmits an ACK to the controller 2.

On receiving the ACK from the terminal device 14 establishing the first communication, the controller 2 transmits a number-of-calls extension execution command for changing the number of slots of the channel CH1 of the repeater 4 to 1.

On receiving the number-of-calls extension execution command, the repeater 4 transmits a bit rate change request signal to the terminal device 14 establishing the first communication to make a notification to restore the audio bit rate to a normal bit rate. The repeater 4 integrates the slot SL1A and the slot SL1B into the single slot SL1. The repeater 4 allocates the first communication to the slot SL1. The repeater 4 transmits a slot shift command for shifting to the slot SL1 to the terminal device 14 establishing the first communication. Thereafter, the repeater 4 changes from a number-of-calls extension mode to a normal mode.

On receiving the bit rate change request signal, the terminal device 14 establishing the first communication restores the audio bit rate to the normal bit rate. On receiving the slot shift command, the terminal device 14 establishing the first communication shifts to the slot SL1 and starts communication.

As described above, in the second embodiment, in the case where a terminal device makes a new connection request when a slot is in use for group communication, it is determined whether or not there is an empty slot between repeaters. In the second embodiment, when there is a repeater with an empty slot, the repeater with an empty slot is caused to manage communication of the terminal device. In the second embodiment, when there is not repeater with an empty slot, a freely-selected repeater is selected and the slot division determination process is performed on the selected repeater. Accordingly, the first embodiment makes it possible to divide the slot appropriately and enable an uninterrupted group call.

### Third Embodiment

When a slot is allocated in response to a connection request from the terminal device 14 that has made the connection request anew, the terminal device 14 serving as a communication partner of the terminal device 14 having made the connection request anew (also referred to as “partner terminal device” below) establishes communication using the slot that is allocated to the terminal device 14 having made the connection request anew. When the slot that is allocated to the terminal device 14 having made the connection request anew is a divided slot, in order to establish communication using the divided slot, the partner terminal device also has to be able to deal with communication according to a bit rate after the division.

Thus, when there is a connection request from the terminal device 14 having made the connection request anew and there is no empty slot, the slot division determination unit 42 checks whether or not destination information or group information containing the terminal device 14 having made the connection request anew is stored in the storage 22. When the destination information or the group information containing the terminal device 14 having made the connection request anew is stored in the storage 22, the slot division determination unit 42 specifies the partner terminal device from the destination information or the group information that is stored. The slot division determination unit 42 makes an inquiry on whether or not a change to a bit rate to be used in the slot after division can be made to the specified partner terminal device. When there is no empty slot and the number of specified partner terminal devices that have responded that the bit rate is changeable in the specified partner terminal devices meets a given condition, the slot division determination process may proceed. In other words, an inquiry on whether or not the bit rate is changeable may be made to the specified partner terminal device as a pre-processing of the slot division determination process. The given condition may be, for example, that the number of specified partner terminal devices that have responded that the bit rate is changeable is a given number. The given condition may be, for example, the number of specified partner terminal devices that have responded that the bit rate is changeable, which is the number set such that the number changes according to the number of the specified partner terminal devices. For example, a given proportion may be set and the condition may be that the given proportion of the number of partner terminal devices is the number of partner terminal devices having responded that the bit rate is changeable.

When the third embodiment is added to the process of the first embodiment and the process is executed, the process may be changed as follows. For example, in FIG. 5 illustrating the process of the first embodiment, when a process of making an inquiry on whether or not the bit rate is changeable to the specified partner terminal device is performed as the pre-processing of the slot division determination process like that in the third embodiment, the following process may be added. Specifically, when it is determined that there is no empty slot in FIG. 5 (No at step S14), before step S18, the slot division determination unit 42 first of all checks whether or not destination information or group information containing the terminal device 14 having made the connection request anew is stored in the storage 22. When the destination information or the group information containing the terminal device 14 having made the connection request anew is stored in the storage 22, the slot division determination unit 42 specifies a partner terminal device from the destination information or the group information that is stored. Thereafter, the slot division determination unit 42 makes an inquiry on whether or not a change to a bit rate to be used in a slot after division can be made to the specified partner terminal device. When the number of specified partner terminal devices that have responded that the bit rate is changeable in the specified partner terminal devices meets the given condition, the following slot division determination process (step S18) may proceed. When the number of specified partner terminal devices that have responded that the bit rate is changeable in the specified partner terminal devices does not meet the given condition, because it is not possible to establish communication with the partner terminal device even if a divided slot is allocated, a disconnection signal is transmitted to the terminal device 14 having made the connection request anew (step S32) and the process ends.

When the third embodiment is added to the process of the second embodiment and the process is executed, the process may be changed as follows. For example, in FIG. 17 illustrating the process of the second embodiment, when a process of making an inquiry on whether or not the bit rate is changeable to the specified partner terminal device is performed as the pre-processing of the slot division determination process like that in the third embodiment, the following process may be added. Specifically, when it is determined that there is no repeater with an empty slot in FIG. 17 (No at step S204), before step S208, the slot division determination unit 42 first of all checks whether or not destination information or group information containing the terminal device 14 having made the connection request anew is stored in the storage 22. When the destination information or the group information containing the terminal device 14 having made the connection request anew is stored in the storage 22, the slot division determination unit 42 specifies a partner terminal device from the destination information or the group information that is stored. Thereafter, the slot division determination unit 42 makes an inquiry on whether or not a change to a bit rate to be used in a slot after division can be made to the specified partner terminal device. When the number of specified partner terminal devices that have responded that the bit rate is changeable in the specified partner terminal devices meets the given condition, a repeater with an empty slot may be selected (step S208), a number-of-calls extension request command may be transmitted (step S210), and the following slot division determination process (step S18) may proceed. When the number of specified partner terminal devices that have responded that the bit rate is changeable in the specified partner terminal devices does not meet the given condition, because it is not possible to establish communication with the partner terminal device even if a divided slot is allocated, a disconnection signal is transmitted to the terminal device 14 having made the connection request anew (step S226) and the process ends.

### Modification of Third Embodiment

In the third embodiment, the slot division determination unit 42 specifies the partner terminal device from the destination information or the group information that is stored in the storage 22 and that contains the terminal device 14 having made the connection request anew and makes the inquiry on whether or not a change to the bit rate to be used in the slot after division can be made to the specified partner terminal device. In a modification, information indicating whether or not the partner terminal device is able to change the bit rate may be stored in the storage 22 and, instead of making an inquiry on whether or not the bit rate is changeable to the partner terminal device, the slot division determination unit 42 may refer to the information that indicates whether or not the bit rate is changeable on each specified partner terminal device and that is stored in the storage 22, and when the number of partner terminal devices that are able to change the bit rate is specified from the referred information and the given condition is met, the slot division determination process may proceed.

As described above, in the third embodiment and the modification of the third embodiment, when there is the connection request from the terminal device 14 having made the connection request anew and there is no empty slot, the partner terminal device is specified from the destination information or the group information containing the terminal device 14 having made the connection request anew, and the inquiry on whether or not the change to the bit rate to be used in the slot after division is made to the specified partner terminal device. When there is no empty slot and the number of specified partner terminal devices that have responded that the bit rate is changeable in the specified partner terminal devices meets the given condition and when the number of partner terminal devices that are able to change the bit rate is specified and the given condition is met, the slot division determination process is performed. Accordingly, even when the divided slot is allocated, it is possible to check previously that it is possible to establish communication between the terminal device 14 having made the connection request anew and the partner terminal device of the terminal device 14 and then divide the slot appropriately, thereby enabling an uninterrupted group call.

Each component of each of the devices illustrated in the drawings is a functional idea and need not necessarily be configured physically as illustrated in the drawings. In other words, specific modes of distribution and integration of each device are not limited to those illustrated in the drawings and all or part of the device may be functionally or physically distributed or integrated in any unit according to various types of load and usage. Note that the configuration according to the distribution and integration may be made dynamically.

The embodiments of the disclosure have been described; however, the content of the embodiments does not limit the disclosure. Note that the above-described components cover ones easily reached by those skilled in the art, ones substantially the same, that is, ones in the scope of equivalents. Furthermore, the above-described components can be combined as appropriate. Furthermore, various omissions, replacements, changes of the components can be made without departing from the scope of the above-described embodiments.

According to the disclosure, it is possible to allocate a slot appropriately to a terminal device.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A management apparatus that has a plurality of slots and that, on receiving a new connection request via a control slot in a state where all call slots are used for calls, deals with the connection request, the management apparatus comprising:
a communication unit that communicates with a terminal device, using the call slot and the control slot;
a slot division determination unit that, on receiving a new connection request via the control slot when there is no empty call slot, selects an inquiry subject slot from the in-use call slots based on a given condition, that makes an inquiry on whether or not a bit rate is changeable to in-use terminal devices using the selected inquiry subject slot, and that, when the in-use terminal devices respond that the bit rate is changeable, determines that the inquiry subject slot is a dividable slot;
a slot division control unit that makes an instruction to change the bit rate to the in-use terminal devices and that divides the dividable slot; and
a slot allocation unit that allocates the in-use terminal devices and a request terminal device having made the new connection request respectively to slots obtained by the division,
wherein, in a case where the inquiry subject slot is used for a group call, the slot division determination unit determines that the terminal devices that include the transmitting terminal device and the at least two receiving terminal devices and that are the in-use terminal devices and makes an inquiry on whether or not the bit rate is changeable to the terminal devices, the slot division determination unit determines that the inquiry subject slot is the dividable slot when the number of in-use terminal devices having responded that the bit rate is changeable in the in-use terminal devices meets a given condition.

2. The management apparatus according to claim 1, wherein the slot division determination unit selects the inquiry subject slot based on the number of the in-use terminal devices that are using the call slots.

3. The management apparatus according to claim 2, wherein, when selecting the inquiry subject slot, the slot division determination unit lowers priority of selecting the call slot being used for the group call.

4. The management apparatus according to claim 1, wherein, when the number of the in-use terminal devices having responded that the bit rate is changeable meets the given condition in a given time, the slot division determination unit determines that the inquiry subject slot is the dividable slot.

5. The management apparatus according to claim 1, further comprising a storage that stores destination information or group information that is used to specify a terminal device serving as a communication partner,
wherein, when there is no empty call slot and a new connection request is received via the control slot, the slot division determination unit specifies a partner terminal device that communicates with a terminal device that has made the new connection request from the destination information or the group information that is stored in the storage and makes an inquiry on whether or not the bit rate is changeable, when the partner terminal device responds that the bit rate is changeable, selects an inquiry subject slot from the in-use call slots based on the given condition, makes an inquiry on whether or not the bit rate is changeable to the in-use terminal devices using the selected inquiry subject slot, and, when the in-use terminal devices respond that the bit rate is changeable, determines that the inquiry subject slot is a dividable slot.

6. A communication control method of, with a plurality of slots, on receiving a new connection request via a control slot in a state where all call slots are used for calls, dealing with the connection request, the method comprising:
communicating with a terminal device, using the call slot and the control slot;
on receiving a new connection request via the control slot when there is no empty call slot, selecting an inquiry subject slot from the in-use call slots based on a given condition, making an inquiry on whether or not a bit rate is changeable to in-use terminal devices using the selected inquiry subject slot, and, when the in-use terminal devices respond that the bit rate is changeable, determining that the inquiry subject slot is a dividable slot;
making an instruction to change the bit rate to the in-use terminal devices and dividing the dividable slot;
allocating the in-use terminal devices and a request terminal device having made the new connection request respectively to slots obtained by the division,
in a case where the inquiry subject slot is used for a group call, determining that the terminal devices that include the transmitting terminal device and the at least two receiving terminal devices and that are the in-use terminal devices and makes an inquiry on whether or not the bit rate is changeable to the terminal devices, determining that the inquiry subject slot is the dividable slot when the number of in-use terminal devices having responded that the bit rate is changeable in the in-use terminal devices meets a given condition.
